(19) United States
(12) Patent Application Publication
(10) Pub. No.: US 2009/0109436 A1
(43) Pub. Date: Apr. 30, 2009

(54) METHOD FOR MEASURING MICRO-PARTICLE

(76) Inventor: Masataka SHINODA, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/244,099

(22) Filed: Oct. 2, 2008

(30) Foreign Application Priority Data
Oct. 26, 2007 (JP) P2007-278436

(51) Int. Cl. G01N 15/00

(52) U.S. Cl. 356/337

(57) ABSTRACT

A method for measuring a micro-particle caused to flow through a flow channel, includes the steps of: measuring a property of a material to be measured as a micro-particle in a predetermined position of a flow channel for measurement, and measuring properties of one or more reference materials in a predetermined position of a flow channel for reference while the material to be measured is caused to flow through the flow channel for measurement, and the one or more reference materials are caused to flow through the flow channel for reference; and processing a result of the measurement of the material to be measured in accordance with a result of the measurements of the one or more reference materials.

### CROSS REFERENCES TO RELATED APPLICATIONS

The present invention contains subject matter related to Japanese Patent Application JP 2007-278436 filed in the Japan Patent Office on Oct. 26, 2007, the entire contents of which being incorporated herein by reference.

### BACKGROUND OF THE INVENTION

1. Field of the Invention

The present invention relates to a method for measuring a micro-particle, and more particularly to a technique for measuring a micro-particle caused to flow through a flow channel.

2. Description of Related Art

In recent years, a technique for analyzing a small amount of specimen caused to flow through a micro-flow channel or the like in the micro-flow channel has been applied to a wide range of fields, including a bio-related analysis, a chemical analysis, and the like. Moreover, this technique has been expected to be further developed based on attracting a great deal of attention in an application field such as a photonic system, and a development of a technique or the like for processing a surface of a flow channel, and new materials.

A flow cytometry, for example, is given as the field using such a technique. The flow cytometry technique is used on a cell, a protein or the like as a material to be measured, and the analysis of the cell, the protein or the like is performed within a flow channel provided in a substrate or the like. Subsequently, a cell sorting for the material to be measured is carried out based on the analysis result or the like. Therefore, in order to precisely carry out the cell sorting for the material to be measured, it is important to precisely perform the measurement of the material to be measured in the flow channel.

In addition, there is also performed an attempt to measure an electrical property or the like of a cell by using electrodes provided inside a flow channel. Such devices for use therein, for example, are typified by chips for analysis of a protein, a device for use in a mass analysis or the like using a micro-dispenser, a micro-reactor, and the like. It is important for such devices to be capable of performing precise measurements in the flow channel for the purpose of performing a measurement of a property, and an analysis for a reaction in the micro-reactor or the like.

With regard to the fields other than the above field, for example, in the chemical analysis or the like as well, the measurement technique used in such a flow channel is applied as a micro-system technique. For example, the measurement technique concerned is expected to be applied to a micro-chemical analysis system in which a micro-flow channel is provided as a fluidic element on a substrate, and various detectors and the like are integrated, or the like.

In order to precisely measure the various properties of a material to be measured in the flow channel, only a fluid medium for carrying the material to be measured is caused to flow through a flow channel for reference, and a measurement is performed in this state, thereby reflecting the result of the measurement of the fluid medium in the flow channel for reference in the results of measurement of the material to be measured. With regard to such a technique, a micro-chip or the like in which a flow channel for reference is provided in addition to a flow channel for a specimen material is disclosed in Japanese Patent Laid-open No. 2003-4752.

### SUMMARY OF THE INVENTION

However, merely providing the flow channel for reference causes a problem that it may be impossible to precisely grasp a reference value which differs every measurement. In addition, there is encountered a problem that a work efficiency is low because it takes time to perform a work for an advance preparation for the measurement. The problems described above are remarkable in the measurement for, especially, the micro-particles.

In the light of the foregoing, it is therefore desirable to provide a micro-particle measuring method with which micro-particles in a flow channel can be precisely measured.

In order to attain the desire described above, according to an embodiment of the present invention, there is provided a method for measuring a micro-particle caused to flow through a flow channel, including at least the steps of:

measuring a property of a material to be measured as a micro-particle in a predetermined position of a flow channel for measurement, and measuring properties of one or more reference materials in a predetermined position of a flow channel for reference while the material to be measured is caused to flow through the flow channel for measurement, and the one or more reference materials are caused to flow through the flow channel for reference; and

processing a result of the measurement of the material to be measured in accordance with a result of the measurements of the one or more reference materials.

Not only the flow channel for reference is provided, but also the property measurements are performed by using the one or more reference materials, thereby making it possible to reflect the results of the measurements of the properties of the one or more reference materials in detection of the property information on the material to be measured in consideration of a state as well of the micro-particle caused to flow through the flow channel for measurement.

According to the present invention, the micro-particle caused to flow through the flow channel can be precisely measured.

### BRIEF DESCRIPTION OF THE DRAWINGS

FIG. 1 is a flow chart explaining an outline of a method for measuring a micro-particle according to embodiments of the present invention;

FIG. 2 is a conceptual view showing a structure of a flow channel used in a method for measuring a micro-particle according to an embodiment of the present invention;

FIGS. 3A and 3B are respectively spectral graphs explaining an example of processing performed in the method for measuring a micro-particle according to the embodiment of the present invention;

FIG. 4 is a conceptual view explaining a method for measuring a micro-particle according to another embodiment of the present invention;

FIGS. 5A and 5B are respectively a spectral graph and a characteristic curve used in explanation in the case where reference materials shown in FIG. 4 are used;

FIG. 6 is a conceptual view explaining a method for measuring a micro-particle according to still another embodiment of the present invention;

FIG. 7 is a conceptual view explaining a method for measuring a micro-particle according to yet another embodiment of the present invention; and

FIG. 8 is a conceptual view explaining a method for measuring a micro-particle according to a further embodiment of the present invention.

### DETAILED DESCRIPTION OF THE PREFERRED EMBODIMENTS

Hereinafter, embodiments of the present invention will be described in detail with reference to the accompanying drawings. It is noted that the accompanying drawings or the like show typical embodiments of the present invention, and thus the scope of the present invention is not intended to be construed in a limiting sense by the accompanying drawings or the like.

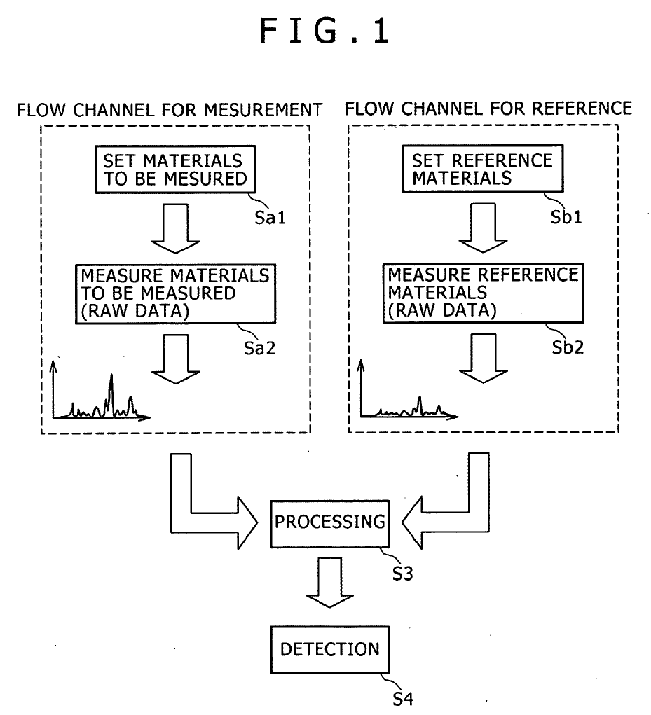

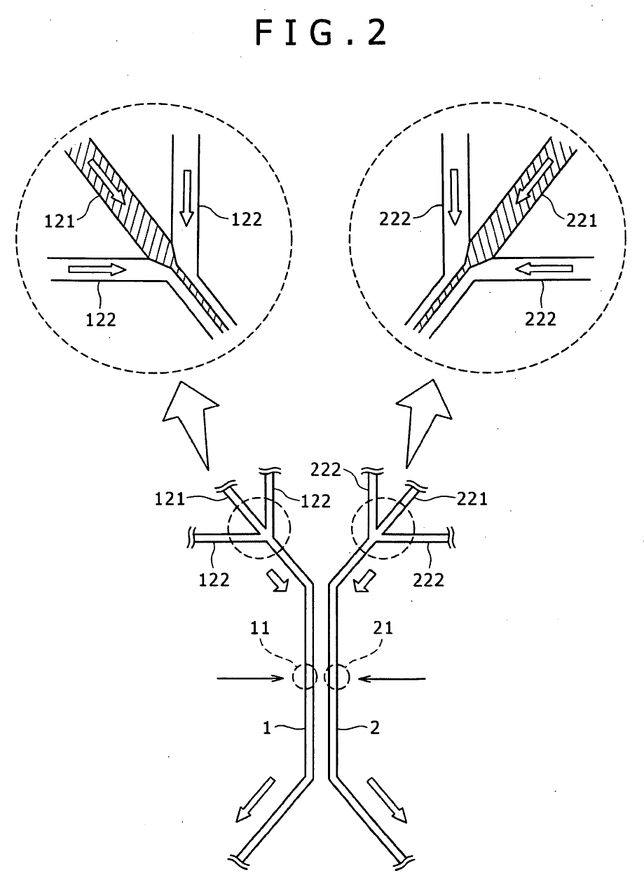

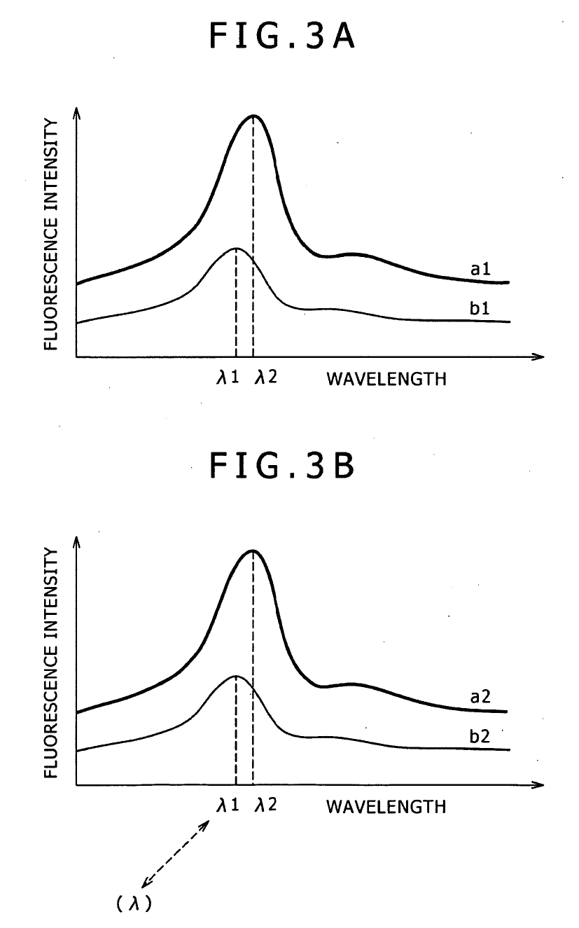

FIG. 1 is a flow chart explaining an outline of a method for measuring a micro-particle according to the present invention. FIG. 2 is a conceptual view showing a structure of a flow channel used in a method for measuring a micro-particle according to an embodiment of the present invention. Also, FIGS. 3A and 3B are respectively spectral graphs explaining an example of processing performed in the method for measuring a micro-particle according to the embodiment of the present invention. Hereinafter, the method for measuring a micro-particle according to the embodiment of the present invention will be described in detail with reference to FIGS. 1 and 2, and FIGS. 3A and 3B. Note that, reference numeral 1 in FIG. 2 designates a flow channel for measurement. Also, reference numeral 2 in FIG. 2 designates a flow channel for reference into which reference materials are introduced.

In the present invention, there are performed at least (1) a step of performing measurements of properties of the materials to be measured as micro-particles in a predetermined position of the flow channel 1 for measurement, and performing measurements of properties of the reference materials in a predetermined position of the flow channel 2 for reference while the materials to be measured are caused to flow through the flow channel 1 for measurement, and the reference materials are caused to flow through the flow channel 2 for reference (step (1)); and (2) a step of processing results of the measurements of the materials to be measured in accordance with results of the measurements of the reference materials (step (2)).

Firstly, the materials to be measured are set in the flow channel 1 for measurement (Step Sa1 in FIG. 1).

Introducing the materials to be measured into the flow channel 1 for measurement, carrying the materials to be measured by a fluid medium while the materials to be measured are held in the fluid medium, and so forth, for example, are given as the setting. This fluid medium can be used as a sheath liquid, and can create a so-called laminar flow state. As a result, the materials to be measured are carried in good order within the flow channel 1 for measurement (refer to a left-hand side enlarged portion of FIG. 2).

The materials to be measured can be introduced from an introduction channel 121 of the flow channel 1 for measurement, and the fluid medium can be introduced from each of introduction channels 122. In particular, the materials to be measured are preferably caused to flow through the flow channel 1 for measurement so as to be held in the fluid medium. As a result, a flow within the flow channel 1 for measurement can be made a laminar flow. The fluid medium can be selected in consideration of the kinds of materials to be measured, and the like. For example, when the cells or the like are the materials to be measured, a normal saline or the like can be used as the fluid medium.

A pressure or the like is suitably adjusted when the fluid medium is introduced from each of the introduction channels 122, thereby making it possible to adjust a carrying speed of the materials to be measured. Moreover, it is possible to precisely control positions of the materials to be measured within the flow channel 1 for measurement.

After that, desired properties of the materials to be measured are measured in a predetermined position 11 within the flow channel 1 for measurement (Step Sa2 in FIG. 1).

The measurements of these properties are performed in the predetermined position 11 within the flow channel 1 for measurement. Which place within the flow channel 1 for measurement the predetermined position 11 is set is by no means limited, and thus can be determined in consideration of the flow channel structure, the measurement conditions, and the like.

On the other hand, the reference materials are similarly set in the flow channel 2 as well for reference (Step Sb1 in FIG. 1).

For the setting, the same operation as that for the materials to be measured in the flow channel 1 for measurement can be performed. For example, injecting the reference materials into the flow channel 2 for reference, and carrying the reference materials while the fluid medium is caused to flow are given as the setting in this case. In the flow channel 2 as well for reference, it is preferable that the reference materials are introduced from an introduction channel 221 of the flow channel 2 for reference, and the fluid medium is introduced from each of introduction channels 222, thereby forming the laminar flow state.

After that, desired properties of the reference materials are measured in a predetermined position 21 within the flow channel 2 for reference (Step Sb2 in FIG. 1).

In this case, the properties measured in the predetermined position 11 within the flow channel 1 for measurement. As has been just described, one of the features of the method for measuring a micro-particle according to the embodiment of the present invention is that not only the flow channel 2 for reference is provided, but also at least the measurements are performed in a state in which the reference materials exist in the flow channel 2 for reference. As a result, the results of the measurements of the reference materials can be used as reference information. The reference information to be obtained is by no means limited, and thus the necessary information corresponding to the properties to be measured can be suitably selected. Information relating to the measurement conditions such as temperatures, flow rates, flow velocities, pH values, viscosities, and specific gravities of micro-particles, and various media in the flow channel, and information relating to states of the reference materials, for example, are given as the reference information. Thus, it is possible to obtain the more detailed reference information.

Moreover, in the embodiment of the present invention, the results of the measurements of the materials to be measured are processed in accordance with the results of the measurements of the reference materials (Step S3 in FIG. 1). The processing stated herein means correcting the results of the measurements of the materials to be measured in accordance with the results of the measurements of the reference materials. Also, the processing technique or the like thereof is by no means limited. For example, a calibration, a correction, standardization, an offset adjustment, a gain adjustment, and the like are given for the processing technique. Specifically, there are given a correction of a fluorescence intensity, a correction of a fluorescence wavelength, a correction of a laser power, a size adjustment of a laser spot, a correction of a sensitivity of a photo-detector or the like, corrections of a flow rate and a flow velocity in a flow channel, and the like. Also, the processing contents can be determined depending on the properties to be measured. This will be described later.

Also, in the embodiment of the present invention, the measurement conditions for the materials to be measured can also be adjusted in accordance with the results of the measurements of the reference materials. That is to say, it is possible to further provide a step of adjusting the measurement conditions for the materials to be measured in accordance with the results of the measurements of the reference materials. Thus, feeding back the results of the measurements of the reference materials to the measurement conditions for the materials to be measured makes possible to perform a more precise measurement. The measurement conditions are not especially limited. For example, the calibration, adjustment, correction, etc. of measurement parameters or the like in a detector and various apparatuses are given as the measurement conditions concerned. Specifically, there are given the measurement conditions relating to the correction of the laser power, the correction of the sensitivity of the detector, the corrections of the flow rate and the flow velocity in the flow channel, and the like. Also, the adjustments for such measurement conditions have to be performed within the step in the embodiment of the present invention, and thus there is no limit to the order of performing the steps, and the like.

For the purpose of enhancing the detection precision, only the fluid medium is caused to flow through the flow channel 2 for reference, and the result of the measurement thereof is reflected as that for reference in the related art. In this case, really, the measurement precision can be improved to some degree because the influence of the fluid medium can be taken into consideration. However, in the case of the measurements of the properties of the micro-particles in the flow channel, the influence of the measurement conditions for the specimens to be measured, and the like are given in addition to the influence of the properties of the fluid medium.

With regard to this, it is essential to the embodiment of the present invention that the reference materials are caused to flow through the flow channel 2 for reference. All the information relating to the properties to be measured is contained in the measurement conditions of the measurements concerned. Thus, at least the measurements in the state in which the reference materials are caused to flow through the flow channel 2 for reference are performed, which results in that the influences or the like of the various measurement conditions, for the materials, such as the temperatures, the flow rates, the flow velocities, the pH values, the viscosities, and the specific gravities of the micro-particles and the fluid medium in the flow channel, and the states of the optical system such as the deterioration with time of the light spot shape and the laser power can also be taken into consideration. As a result, it is possible to obtain the more precise property information.

FIGS. 3A and 3B are respectively spectral graphs explaining an example of processing which can be performed in the embodiment of the present invention. The case where a fluorescence measurement of the material to be measured is performed is described in detail as an example. In this case, a material which is supported by a fluorescent bead is used as the material to be measured, and a fluorescent bead by which no material to be measured is supported is used in the reference material.

For obtaining the spectral graphs shown in FIG. 3A, the measurement results obtained in the flow channel 1 for measurement are processed in accordance with a fluorescence spectrum b1 of the reference material measured in the flow channel 2 for reference to detect a fluorescence spectrum al as the precise property information on the material to be measured. Hereinafter, the fluorescence spectrum of the reference material is referred to as “a reference spectrum” in some cases.

During detection of the fluorescence, the spectral intensity actually measured is not sufficient and a wavelength of a peak-top slightly shifts in some cases depending on the states of the materials carried in the flow channel. Such errors can not be grasped unless only the fluid Medium is caused to flow through the flow channel 2 for reference. However, in the embodiment of the present invention, these errors can be simply and precisely grasped because the fluorescence spectrum b1 of the reference material can be obtained.

For example, when the fluorescence intensity of the fluorescence spectrum b1 of the reference material is weak, the data, on the fluorescence intensity, outputted is corrected based on the result of the measurement of the reference spectrum b1, thereby making it possible to obtain the fluorescence spectrum a1 having a proper fluorescence intensity (gain correction). Alternatively, an intensity of an excitation light radiated from a light source is increased, thereby making it possible to increase the resulting fluorescence intensity. Thus, even when the proper intensity of the excitation light is obtained while reference is made to the intensity of the reference spectrum b1, it is possible to obtain the proper fluorescence spectrum a1 (a correction by using a laser power).

For example, when although a detected peak-top wavelength ought to be λ2, it is detected as λ1 in the reference spectrum, it is possible to grasp that an error (λ2-λ1) occurs. The proper fluorescence spectrum a1 can be obtained by performing the correction in consideration of this error.

Moreover, the feedback can also be made to the correction of the detection precision. Although not illustrated, the proper detection intensity can be obtained by correcting the intensity or the like of the received light in a detector or the like used as a detection portion (a correction by using a photo-detector).

For obtaining the spectral graphs shown in FIG. 3B, the processing is performed not only based on the fluorescence spectrum b2 of the reference material measured in the flow channel 2 for reference, but also based on a numeric value λ of the precise wavelength previously obtained. As a result, the fluorescence spectrum a2 is detected as the precise property information on the material to be measured.

Also, for obtaining the spectral graphs shown in FIG. 3B, the precise information on the wavelength λ and the like of the fluorescent bead intended to be used is previously obtained. As a result, it is possible to detect an error (λ-λ1) between the wavelength λ1 detected with the reference spectrum of the reference material, and the wavelength λ described above.

Also, the information obtained in this processing is detected as the property information on the material to be measured (Step S4 in FIG. 1). As a result, the more precise property information can be obtained, thereby making it possible to reflect the more precise property information in the operation or the like which will be subsequently performed.

The order of the operations performed in the flow channel 1 for measurement (refer to Steps Sa1 and Sa2 in FIG. 1), and the operations performed in the flow channel 2 for reference (refer to Steps Sb1 and Sb2 in FIG. 1) which have been described so far is not limited to the order described herein. The reason for this is because the results of the measurements of the materials to be measured (refer to Step Sa2 in FIG. 1), and the results of the measurements of the reference materials (refer to Step Sb2 in FIG. 1) have to be able to be used in the processing operation (refer to Step 3 in FIG. 1).

Therefore, although the operation is not limited to simultaneously performing the measurement in the predetermined position 11 in the flow channel 1 for measurement, and the measurement in the predetermined position 21 in the flow channel 2 for reference, preferably, those measurements are at least simultaneously performed. As a result, it is possible to more precisely measure the properties because those measurements can be performed under the conditions nearer each other. Moreover, the flow channel 1 for measurement, and the flow channel 2 for reference as shown in FIG. 2 are preferably disposed as close to each other as possible. As a result, it is possible to more precisely measure the properties because making their scanning positions close to each other makes it possible to perform the measurements under the measurement conditions made nearer each other.

Although in the above, the case where the fluorescence is detected as the optical property has been described as the exemplification, in the present invention, the measurable properties are by no means limited thereto. For example, an optical property, an electrical property, a magnetic property, and the like can be measured.

A fluorescence measurement, a scattered light measurement, a transmitted light measurement, a reflected light measurement, a diffracted light measurement, an ultraviolet spectroscopic measurement, an infrared spectroscopic measurement, a Raman spectroscopic measurement, an FRET measurement, an FISH measurement, and various other spectrum measurements can be performed as the measurements of the optical properties which can be performed in the present invention. At that time, the materials to be measured can be supported by the bead or the like, if desired.

Also, in the case where the bead, the cell or the like is used as the reference material, a fluorescent dye can be used when the fluorescence measurement is performed. When the reference material is the cell, the fluorescent dye can be modified on a surface of the cell based on an antigen-antibody complex reaction. On the other hand, when the reference material is the bead, the fluorescent dye may be chemically modified on a surface of the bead, or the inside of the bead may be mixed with the fluorescent dye. Or, a shape or size of the bead may be made to differ. Moreover, the fluorescent dyes different in excitation wavelength from each other may also be used in combination. This will be described later.

The measurements of a resistance value, a capacitance value, an inductance value, and an impedance value which relate to the material to be measured, a change value in electric field applied across opposite electrodes, and the like, for example, can be performed as the measurements of the electrical properties which can be performed in the present invention.

For example, the measurements can be used in the case where the material to be measured is passed through the opposite electrodes, and a frequency spectrum as a direct current component and a high frequency component of an impedance generated across the opposite electrodes is measured, and so forth. In the embodiment of the present invention, some sort of electrical measurement element is formed in the predetermined region 11 of the flow channel 1 for measurement, and the material to be measured is passed through the predetermined region 11 to obtain the electrical property information on the material to be measured. Likewise, an electrical measurement element is formed in the predetermined region 21 of the flow channel 2 for reference, and the reference materials are passed through the predetermined region 21 of the flow channel 2 for reference to obtain the electrical property information on the reference materials. Based on thus obtained electrical property information for reference, the electrical property information on the materials to be measured can be processed.

The measurements of a magnetization, a change in magnetic field, a change in magnetizing field, and the like can be performed as the measurements of the magnetic properties which can be performed in the present invention. For example, a cell obtained by modifying the surface of the cell with a magnetic material, or the magnetic bead can be used. Moreover, The magnetic bead or the like may be tagged with the fluorescent dye to be treated as a unit.

Also, the present invention can also be applied to a technique for collecting and sorting the specific cells by using such a magnetic bead and a magnet, and the like. Although the related art involves a problem that the separation precision is not high so much, the present invention can solve such a problem. For example, the cell obtained by reacting a monoclonal antibody or the like and the magnetic bead with each other can be passed through each of the flow channel 1 for measurement, and the flow channel 2 for reference which are disposed in a strong magnetic field to measure (and separate) the cell. For example, the material to be measured is passed through Opposite magnetic coils, thereby making it possible to measure a frequency spectrum as a direct current component and a high frequency component of the magnetic field generated. Or, a change in magnetization can also be measured by using a magnetic resistance element or the like.

As described above, the bead, the cell or the like can be used as the reference material. Also, it is possible to adopt various kinds of beads which are normally used as the beads. For example, it is possible to use the bead made of a resin such as polystyrene, or the bead made of a glass. Moreover, the bead can be used which is obtained by mixing or modifying the surface or inside of the bead concerned with the fluorescent dye, a magnetic material, a conductor, an optical material or the like. For example, it is possible to use the resin bead, the fluorescent bead, the magnetic bead or the like. Moreover, a size, a shape and the like of such a bead can be suitably selected. For example, such a bead may be of a shape such as an ellipsoidal body, a cube, or a rectangular parallelepiped in addition to a spherical body. Also, such a bead can be selected depending on the properties to be measured.

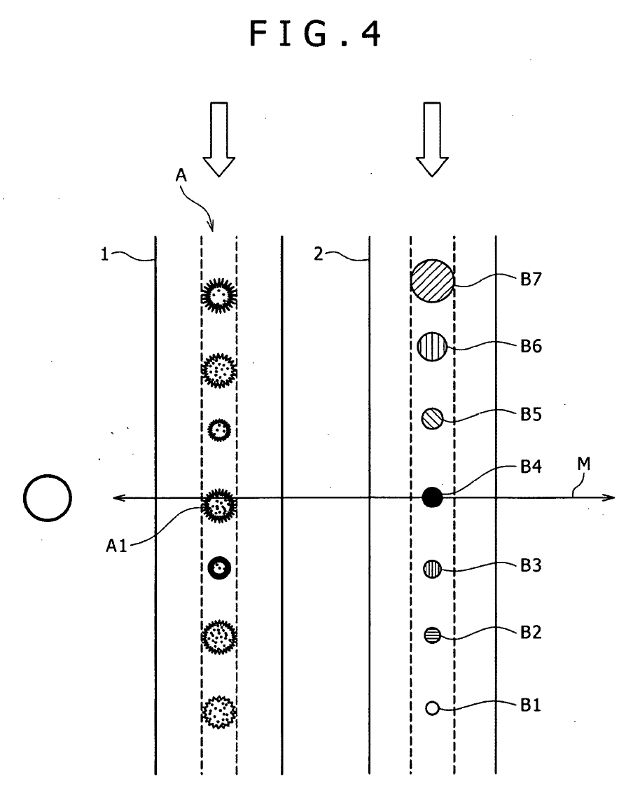

FIG. 4 is a conceptual view explaining another embodiment of the present invention.

Referring to FIG. 4, materials to be measured are caused to flow through the flow channel 1 for measurement, and reference materials B1, B2, B3, B4, B5, B6, and B7 are each caused to flow through the flow channel 2 for reference. A light (excitation light) is radiated to the materials to be measured, and the reference materials B1, B2, B3, B4, B5, B6, and B7, thereby performing fluorescence detection or the like. Also, the light is radiated by scanning a light spot M for measurement to both the flow channel 1 for measurement, and the flow channel 2 for reference (refer to a two-headed arrow in FIG. 4).

Materials A to be measured are carried in order through the flow channel 1 for measurement in a direction indicated by an arrow. The materials A to be measured are different in size, shape, etc. from one another. In this case, for the sake of convenience of a description, the description is given by paying attention to a material A1 to be measured located on a measurement light spot illustrated in the figure (refer to the two-headed arrow in FIG. 4). A laminar flow is formed in the flow channel 1 for measurement, which results in that the material A1 to be measured is carried approximately along a central portion of the flow channel 1 for measurement (refer to parallel dotted lines). The material A1 to be measured is obtained by supporting a specimen desired to be measured with the fluorescent bead. Thus, a fluorescence and a forward-scattered light are both detected by using the measurement light spot. It is noted that the cell, the bead or the like is given as the specimen desired to be measured.

Seven kinds of fluorescent beads are carried as the reference materials B1 to B7 in series through the flow channel 2 for reference in a direction indicated by an arrow. Also, the laminar flow is formed in the flow channel 2 for reference, which results in that the reference materials B1 to B7 are carried in series approximately along a central portion of the flow channel 2 for reference (refer to parallel dotted lines). One of the features in this embodiment shown in FIG. 4 is that the reference materials B1 to B7 use the fluorescent beads each being different in kind from that of the material A1 to be measured, and the beads of the reference materials B1 to B7 are different in diameter and fluorescence wavelength from one another.

It is noted that using the fluorescent beads different in diameter and fluorescence wavelength from one another is an example when the fluorescence, the forward-scattered light, and the like are detected. In FIG. 4, there are used a plurality kind of reference materials B1 to B7 (fluorescent beads) having the beads different in diameter and fluorescence wavelength from one another. In this embodiment of the present invention, when a plurality kind of reference materials are used, what measurement parameters are made to differ can be suitably determined depending on the properties (the optical property, the electrical property, the magnetic property, and the like) desired to be measured.

In the embodiment of the present invention, it is preferable to scan and radiate the excitation light to each of the flow channel 1 for measurement, and the flow channel 2 for reference. Scanning the excitation light to each of the flow channel 1 for measurement, and the flow channel 2 for reference makes it possible to radiate the excitation light to each of the material A1 to be measured and the reference materials B1 to B7. Also, scanning these flow channels in series with the excitation light makes it possible to continuously make reference to the property information desired to be obtained (such as a spectral intensity distribution) on which attention is focused. As a result, it is possible to more precisely detect the property of matter.

The scanning technique is by no means limited. Thus, the scanning can be performed by using the known technique using an optical scanning element or the like such as a galvano-mirror, a polygon mirror or an MEMS. In addition, lights different in wavelength from one another may be radiated in a time division manner, if desired. As a result, the measurements about a plurality of wavelengths become possible. This results in that more reference information can be obtained, and thus the property can be precisely measured. In addition, the flow channel 1 for measurement, and the flow channel 2 for reference are preferably disposed close to each other. Also, the precise measurements including the measurement conditions and the measurement states become possible because performing the optical scanning makes it possible to set the measurement conditions to ones closer to each other.

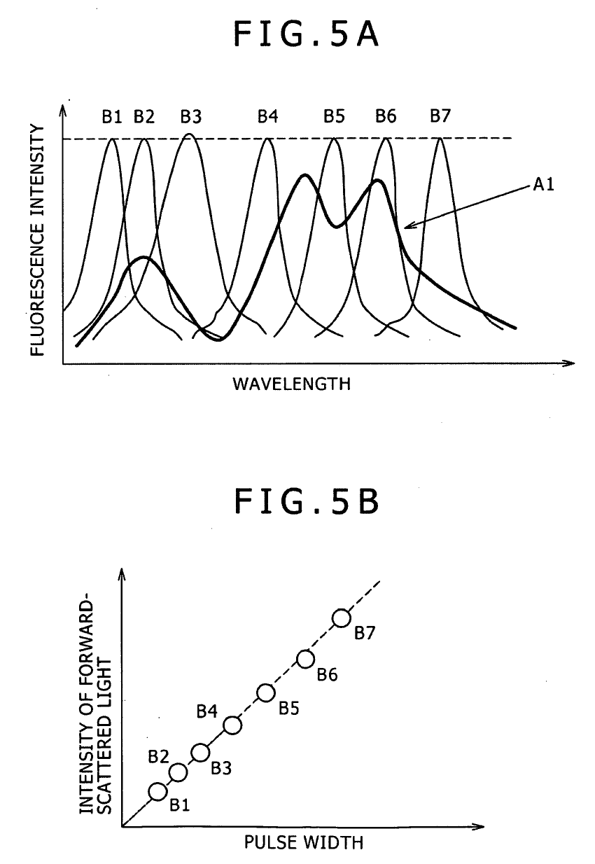

FIGS. 5A and 5B are respectively a spectral graph and a characteristic curve used in explanation in the case where the reference materials shown in FIG. 4 are used. An example shown in this case is one when the fluorescence and the forward-scattered light are detected by using the seven kinds of reference materials B1 to B7.

There are used the seven kinds of reference materials B1 to B7 different in fluorescent dye and bead diameter from one another. Each of the seven kinds of reference materials B1 to B7 can be detected in the predetermined position (for example, the predetermined positions 21 or the like in FIG. 2) within the flow channel 2 for reference. Table 1 shows names of the fluorescent dyes and the bead diameters.

TABLE 1

| Reference | Name of | Bead diameter |
|---|---|---|
| material | fluorescent dye | [μm] |
| B1 | Cascade Blue | 0.5 |
| B2 | FITC | 1 |
| B3 | PE | 2 |
| B4 | PE-Texas Red | 4 |
| B5 | PE-Cy5 | 8 |
| B6 | APC | 16 |
| B7 | APC-Cy7 | 32 |

In the reference material B1, Cascade Blue is used as the fluorescent dye, and the bead diameter is 0.5 μm. In the reference material B2, FITC is used as the fluorescent dye, and the bead diameter is 1 μm. In the reference material B3, PE is used as the fluorescent dye, and the bead diameter is 2 μm. In the reference material B4, PE-Texas Red is used as the fluorescent dye, and the bead diameter is 4 μm. In the reference material B5, PE-Cy5 is used as the fluorescent dye, and the bead diameter is 8 μm. In addition, in the reference material B6, APC is used as the fluorescent dye, and the bead diameter is 16 μm. Also, in the reference material B7, APC-Cy7 is used as the fluorescent dye, and the bead diameter is 32 μm.

The fluorescences are detected in the form of spectra which are different from one another depending on the excitation wavelengths and absorption wavelengths of the fluorescent dyes used. For this reason, as shown in FIG. 5A, seven wavelength peaks corresponding to the fluorescent dyes are recognized for the reference materials B1 to B7, respectively (refer to reference symbols B1 to B7 in FIG. 5A).

It is noted that the spectra shown in FIG. 5A are obtained by normalizing the reference spectra actually measured. In the embodiment of the present invention, the measurement results obtained from a plurality of reference materials B1 to B7, respectively, are preferably normalized before being processed (for example, refer to Step S3, etc. in FIG. 1). In particular, when the light radiation is performed by carrying out the scanning, minute deviations of the detected waveforms, the deviations of the intensities of the detected signals, and the like readily occur in the materials for measurement. The results of the measurements of the materials for measurement are normalized, which results in that such deviations and the like can be dissolved, and thus the proper evaluation can be performed.

Moreover, as shown in FIG. 5A, when the measurement spectrum of the material A1 to be measured is processed (for example, refer to Step S4, etc. in FIG. 1), a fluorescent spectral signal based on the material A1 to be measured can be processed as a linear sum of the spectra of the seven kinds of fluorescent dyes, and in this state can be subjected to an inverse matrix analysis. The technique for the inverse matrix analysis performed herein is not especially limited. Thus, the suitable technique can be selected in consideration of parameters desired to be measured, the number of reference materials, and the like.

In the embodiment of the present invention, numeric values which are previously known about the fluorescent dyes may be used in combination, if desired. For example, in the case of the spectral graph shown in FIG. 5A, the excitation wavelengths and the fluorescence wavelengths are previously obtained about a part of the seven kinds of fluorescent dyes, and they can be used. Moreover, a part of the parameter information which should be actually measured about the reference materials can also be previously obtained in the form of a library.

FIG. 5B shows a relationship between a pulse width and an intensity of a forward-scattered light with respect to the seven kinds of reference materials B1 to B7 in the flow channel 2 for reference. Since the seven kinds of reference materials B1 to B7 are different in bead diameter from one another, the forward-scattered lights obtained from the reference materials B1 to B7 are different in pulse width and intensity of the forward-scattered light from one another. For this reason, it is possible to obtain raw data corresponding to at least the diameters of the seven kinds of beads, respectively. As a result, for example, it is possible to grasp a correlation or the like among a relationship between the intensity of the forward-scattered light, and the pulse width, and the bead diameter corresponding thereto. Also, it is possible to estimate the diameter or the like of the material A1 to be measured in the flow channel 1 for measurement with a high precision. In particular, there is encountered a problem that not only the flow in the flow channel, but also the size of the bead itself, the position in the flow channel of the bead, the alignment of the light, and the like exert a large influence on the detection of the forward-scattered light. In order to cope with this problem, in particular, a plurality of reference materials different in size from one another are used, thereby making it possible to more precisely detect the forward-scattered lights.

Although the case where the fluorescences and the forward-scattered lights are detected has been described here as an example, the measurement parameters other than the fluorescence and the forward-scattered light can also be similarly detected. A plurality kind of different materials for measurement are used in combination to obtain the measurement results for reference, and the results of the measurements of the materials to be measured are processed based on these measurement results, thereby making it possible to detect the precise measurement information on the materials to be measured.

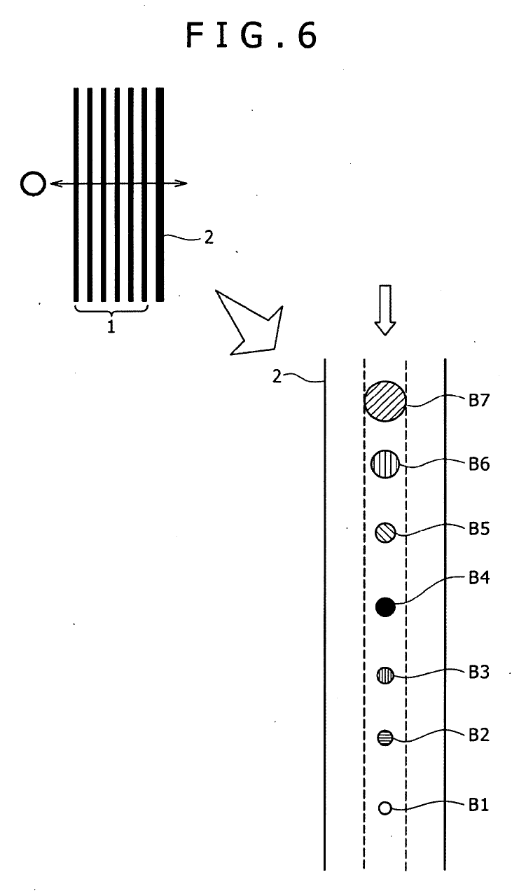

FIG. 6 is a conceptual view explaining still another embodiment of the present invention.

Referring now to FIG. 6, six flow channels 1 for measurement are disposed approximately in parallel with one another, and materials A to be measured are caused to flow through the six flow channels 1 for measurement, respectively. Also, one flow channel 2 for reference is disposed approximately in parallel with the six flow channels 1 for measurement on one side, and reference materials B1, B2, B3, B4, B5, B6, and B7 are caused to flow through the one flow channel 2 for reference in order. It is to be noted that the materials A to be measured which are supported by the fluorescent beads are carried to flow through the six flow channels 1 for measurement in series, respectively, in a direction indicated by an arrow. A plurality of flow channels 1 for measurement are disposed in the manner described above, thereby making it possible to collectively perform the measurements. In this case, the measurements are performed while the light radiation is scanned for the six flow channels 1 for measurement, and the one flow channel 2 for reference, which results in that the measurements can be efficiently performed (refer to a two-headed arrow in FIG. 6). In addition, during the scanning, the dispersion caused by the deterioration with time, or the like exerts an influence on the measurement results in some cases. However, in the embodiment of the present invention, the results of the measurements of the reference materials B1 to B7 can also be obtained with time. Therefore, the information on the measurements of the materials to be measured can be corrected while such a dispersion is also successively corrected.

Seven kinds of fluorescent beads are carried in order through the flow channel 2 for reference in a direction indicated by an arrow. In particular, when a plurality of materials to be measured are detected, the more reference information can be obtained by using a plurality of reference materials in the manner described above, which is preferable. As a result, this can contribute not only to the space saving in terms of the flow channel structure, but also to the exhaustive analysis.

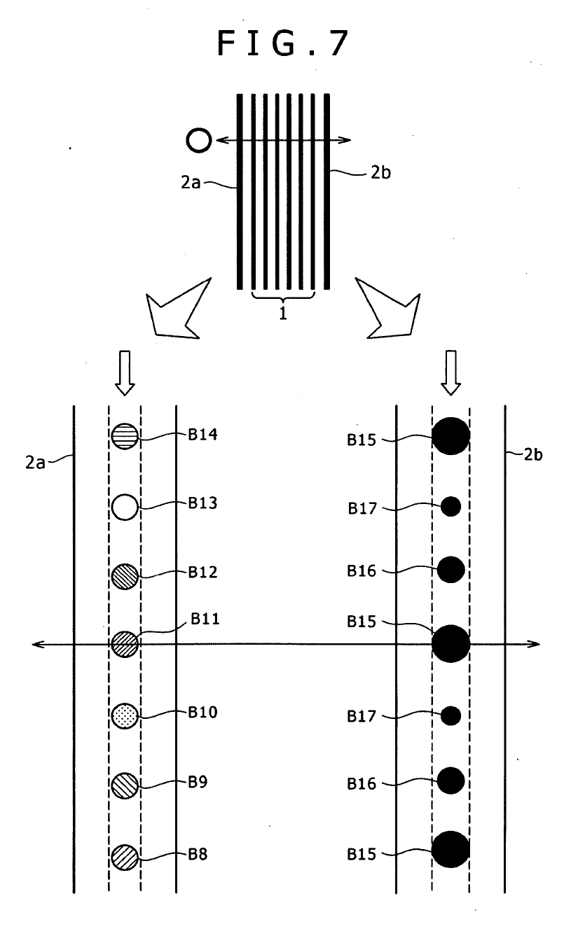

FIG. 7 is a conceptual view explaining yet another embodiment of the present invention.

Referring now to FIG. 7, six flow channels 1 for measurement are disposed approximately in parallel with one another in order to cause materials to be measured to flow through the six flow channels 1 for measurement, respectively. Also, flow channels 2a and 2b for reference are disposed on both sides of the six flow channels 1 for measurement, respectively, in order to measure reference materials. It is noted that the materials A to be measured which are supported by fluorescent beads are carried through the flow channels 1 for measurement, respectively, in a direction indicated by an arrow. The materials to be measured caused to flow through a plurality of flow channels 1 for measurement, and the reference materials caused to flow through a plurality of flow channels 2a and 2b for reference can also be collectively measured, if desired. Hereinafter, a description about points common to the embodiments described above will be omitted, and a description will be made mainly for points of difference.

Reference materials B8, B9, B10, B11, B12, B13, and B14 which are identical in bead diameter to one another, and different in fluorescent dye from one another are successively carried through the flow channel 2a for reference. On the other hand, reference materials B15, B16 and B17 which have none of the fluorescent dyes, and are different in bead diameter from one another are successively carried through the flow channel 2b for reference.

As described above, in the embodiment of the present invention, a plurality of flow channels for reference can be used, and a plurality of different reference materials can be carried through the plurality of flow channels for reference. In addition, in addition to the flow channels 2a and 2b for reference each carrying the reference materials, a flow channel for reference through which no reference material is caused to flow and only the fluid medium is caused to flow may be specially provided.

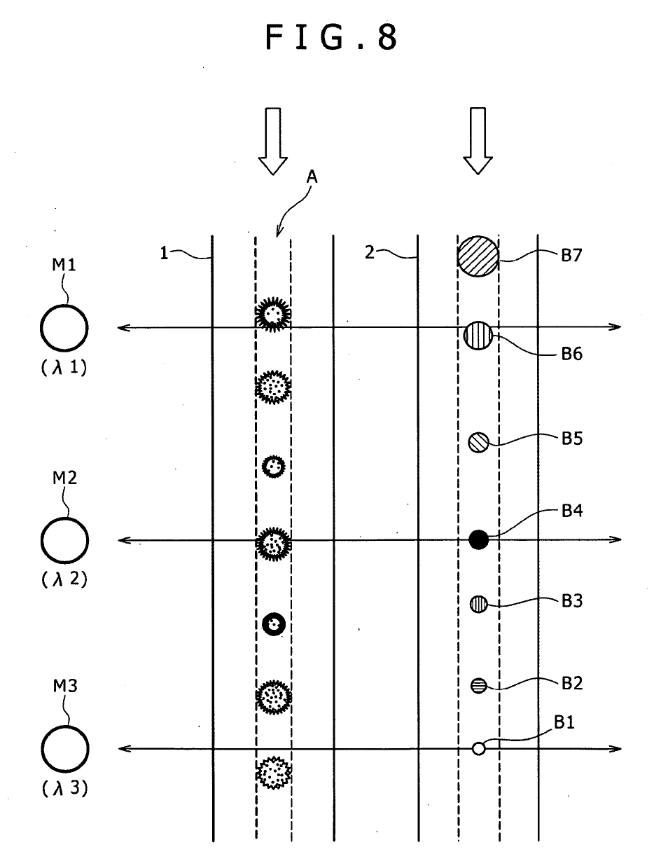

FIG. 8 is a conceptual view explaining a further embodiment of the present invention.

Referring now to FIG. 8, although materials A to be measured are carried through a flow channel 1 for measurement, and a plurality of different reference materials B1, B2, B3, B4, B5, B6, and B7 are carried through a flow channel 2 for reference, measurements are performed in three measurement spots M1, M2 and M3, respectively, in each of the flow channel 1 for measurement and the flow channel 2 for reference. One of the features of this embodiment shown in FIG. 8 is that the measurements are performed in a plurality of portions, respectively, in each of the flow channel 1 for measurement and the flow channel 2 for reference.

Also, lights different in wavelengths from one another can be radiated to the measurement spots M1, M2 and M3, respectively. The measurements using a plurality of different wavelengths are performed in the flow channel, thereby making it possible to measure the more properties of matter. For example, the three lights having different excitation wavelengths λ1, λ2 and λ3 are radiated to the three measurement spots M1, M2 and M3, respectively, thereby making it possible to perform the optical measurements such as the detection of the fluorescence and the detection of the forward-scattered light by using a plurality of different wavelengths. Moreover, the measurements about the electrical characteristics and magnetic characteristics described above may be performed. Or, combining the measurements about the electrical characteristics and the magnetic characteristics with each other makes it possible to obtain the multi-factorial reference information. With regard to the electrical characteristics and the magnetic characteristics as well, using the reference materials B1, B2, B3, B4, B5, B6, and B7, or performing the measurements in a plurality of different measurement positions makes it possible to perform the highly precise measurements and detection. Moreover, the detection and the measurements can be performed in real time.

In addition to the flow channel 1 for measurement through which the cell or bead as an object of the measurement, the flow channel 2 for reference through which the bead for obtaining the reference spectrum and the reference diameter can be provided in a substrate or the like. In this case, the measurement light spot is scanned so that the measurements can be approximately, and simultaneously performed for the flow channel 1 for measurement, and the flow channel 2 for measurement, thereby making it possible to continuously refer to the reference spectrum, the reference diameter, the spectral intensity, the distribution thereof, and the like with time.

Also, the processing is performed based on the reference spectrum and the reference diameter, which results in that the precision for the quantitativeness of the property measurement can be further enhanced. In addition, the reference spectrum can be utilized as the reference spectrum as well of the cell, the bead or the like as an object of the measurement. In this case as well, the highly precise analysis excellent in quantitativeness becomes possible because the spectral intensity and distribution obtained under the same optical condition and aqueous stream condition can be utilized.

In addition thereto, it is possible to prevent and correct deviations or the like in the optical system and the aqueous stream system during the measurement, and in the alignment in the optical system and the cell sorting system. In addition, the work or the like for the advance preparation is reduced for the worker, which can contribute to the improvement in the work efficiency.

The method for measuring a micro-particle according to the embodiments of the present invention can be suitably used as the technique or the like for analyzing the minute material such as the cell within the flow channel. For example, the method for measuring a micro-particle according to the present invention is expected to be applied to a flow cytometry, a bead assay or the like. In the flow cytometry, the technique relating to the present invention can be applied to the optical system or the like for measuring the fluorescence analysis, the forward-scattered (FSC) light, a side scattered (SSC) light or the like. According to the present invention, many cells can be precisely measured for a short time period. In addition, the processing based on the results or the like of the measurements of the reference materials is performed, which results in that even a light weak for detection can be detected. Or, the radiation and the detection are performed for the reference materials, and the materials to be detected by the optical scanning, which results in that the reference materials, and the materials to be detected can be measured approximately under the same conditions.

In addition, by using a plurality kind of reference materials, the technique of a cluster analysis can also be applied, and thus an objective cell group can be analyzed with a high precision. Therefore, the cell sorting for the specific cells can also be performed at a high speed.

In addition, the present invention can also be applied to a micro-reactor for performing a predetermined reaction such as a chemical reaction in a minute flow channel or the like. When the light radiation is performed within the flow channel for a spectroscopic measurement or heating, the spectroscopic measurement or heating can be reflected in the radiation control. For example, when laser radiation is performed, an output power of the laser can be controlled in consideration of optical information detected (such as a fluorescence intensity).

It should be understood by those skilled in the art that various modifications, combinations, sub-combinations and alterations may occur depending on design requirements and other factors insofar as they are within the scope of the appended claims or the equivalents thereof.

What is claimed is:

1. A method for measuring a micro-particle caused to flow through a flow channel, comprising the steps of:
measuring a property of a material to be measured as a micro-particle in a predetermined position of a flow channel for measurement, and measuring properties of one or more reference materials in a predetermined position of a flow channel for reference while said material to be measured is caused to flow through said flow channel for measurement, and said one or more reference materials are caused to flow through said flow channel for reference; and
processing a result of the measurement of said material to be measured in accordance with a result of the measurements of said one or more reference materials.

2. The method for measuring a micro-particle according to claim 1, wherein the different kinds of reference materials are used, and in said processing step, the result of the measurement of said material to be measured is processed in accordance with the different results of the measurements of said different kinds of reference materials.

3. The method for measuring a micro-particle according to claim 1, wherein a step of adjusting a measurement condition for said material to be measured in accordance with the result of the measurement of said one or more reference materials is performed at least in said measurement step.

4. The method for measuring a micro-particle according to claim 1, wherein the property to be measured is at least any of an optical property, an electrical property, or a magnetic property.

5. The method for measuring a micro-particle according to claim 4, wherein the measurement is an optical measurement for detecting a measurement object light obtained by radiating a light to said material to be measured and said one or more reference materials; and
the light radiation to said material to be measured, and said one or more reference materials is made by at least performing light scanning.

6. The method for measuring a micro-particle according to claim 1, wherein at least beads and/or cells are used as said one or more reference materials.

7. The method for measuring a micro-particle according to claim 6, wherein said beads and/or said cells used as said one or more reference materials are different in particle size from one another.

8. The method for measuring a micro-particle according to claim 6, wherein said beads and/or said cells used as said one or more reference materials are different in particle shape from one another.

9. The method for measuring a micro-particle according to claim 6, wherein said beads and/or said cells used as said one or more reference materials have at least fluorescent dyes.

10. The method for measuring a micro-particle according to claim 6, wherein said beads and/or said cells used as said one or more reference materials have at least magnetic materials.
